(19) United States
(12) Patent Application Publication
(10) Pub. No.: US 2022/0148460 A1
(43) Pub. Date: May 12, 2022

(54) INCISION MODEL TO DEMONSTRATE CLOSURE EFFECTIVENESS

(71) Applicant: KCI LICENSING, INC., San Antonio, TX (US)

(72) Inventors: Colin John HALL, Poole (GB); Christopher Brian LOCKE, Bournemouth (GB); Benjamin A. PRATT, Poole (GB)

(21) Appl. No.: 17/435,524

(22) PCT Filed: Feb. 25, 2020
(86) PCT No.: PCT/US2020/019593

§ 371 Date: Sep. 1, 2021

Related U.S. Application Data
(60) Provisional application No. 62/816,530, filed on Mar. 11, 2019.

(51) Int. Cl. G09B 23/34

(52) U.S. Cl. CPC G09B 23/34

(57) ABSTRACT

A wound incision model includes an outer frame defining and opening and a simulated tissue disposed at least partially within the opening. The simulated tissue includes a body and a simulated wound. The simulated wound is disposed at least partially within the body. The simulated wound includes an aperture extending through the body from a first surface of the body to a second surface of the body. The simulated wound is configured to deform in response to a negative pressure applied across the simulated wound.

### CROSS-REFERENCE TO RELATED APPLICATIONS

This application claims the benefit of priority to U.S. Provisional Application No. 62/816,530, filed on Mar. 11, 2019, which is incorporated herein by reference in its entirety.

### BACKGROUND

The present disclosure relates generally to models used to demonstrate the performance of a medical device. More specifically, the present disclosure relates to an incision model for a wound site.

Suture techniques for closed incisional wound surgery may result in a region of dead space (e.g., open volume) beneath the repaired skin. This dead space may result in delayed healing of the wound and increases a patient's overall risk of infection. Negative pressure wound therapy (NPWT) devices may be used to reduce recovery time and the associated risk of infection. These devices produce a negative pressure across the wound above the repaired incision. The application of negative pressure helps to reduce the dead space beneath the repaired skin. However, the amount of closure force provided by different devices varies greatly. These differences in wound closure performance are difficult to demonstrate as the dead space beneath an upper layer of the incisional wound cannot be observed through the suture.

### SUMMARY

One implementation of the present disclosure is a wound incision model. The wound incision model includes an outer frame defining an opening and a simulated tissue disposed at least partially within the opening. The simulated tissue includes a body and a simulated wound disposed at least partially within the body. The simulated wound includes an aperture extending through the body from a first surface of the body to a second surface of the body. The simulated wound is configured to deform in response to a negative pressure applied across the simulated wound.

In any of the above embodiments, the simulated wound may further include at least two walls defining a perimeter of the aperture. The walls may be oriented substantially normal to the first surface or the second surface. The walls may be configured to deform in response to the negative pressure applied across the simulated wound. In some instances, the walls may include a different material than the body. For example, the walls may include a color pigment. The body may be substantially transparent. In some instances, the body may include a soft cast silicone material including a mixture of siliglass and prosthetic deadener. For example, the soft cast silicone material may include a mixture ratio of 1 part siliglass to 6 parts prosthetic deadener.

In some embodiments, a cross-section through the aperture is substantially elliptical when viewed normal to the first surface or the second surface. The size of the aperture decreases with increasing negative pressure. In some instances, the aperture is configured to close when the negative pressure is greater than or equal to approximately 125 mm Hg.

In some embodiments, the wound incision model may include a panel disposed on the first surface of the body. In some instances, the panel may be optically transparent. In yet other instances, the panel may include rule gradations configured to measure deformation of the aperture.

In any of the above embodiments, the simulated tissue may further include a skin layer on the second surface of the body. In some instances, a thickness of the skin layer normal to the second surface may be less than a thickness of the body.

In some embodiments, the wound incision model may include a sensor configured to measure a deformation of the simulated wound or the negative pressure applied across the simulated wound. For example, the sensor may include an electro-active polymer (EAP) sensor molded into the body. The EAP sensor may be configured to extend and deform with the body in response to the negative pressure applied across the simulated wound. In other embodiments, the sensor may include a pneumatic pressure sensor including a dial pressure gage that is at least partially disposed within the outer frame. In some instances, the sensor may be electrically coupled to an electronics module disposed within the outer frame. The electronics module may include a network communications interface configured to wirelessly transmit sensor data from the sensor.

Another implementation of the present disclosure is a simulated tissue. The simulated tissue includes a body and a simulated wound disposed at least partially within the body. The simulated wound includes an aperture extending through the body from a first surface of the body to a second surface of the body. The simulated wound is configured to deform in response to a negative pressure applied across the simulated wound.

In some embodiments, the simulated wound includes at least two walls defining a perimeter of the aperture. The walls may be oriented substantially normal to the first surface or the second surface of the body. The walls may be configured to deform in response to the negative pressure applied across the simulated wound.

In some instances, the walls may include a different material than the body. For example, the walls may include a color pigment. The body may include a soft cast silicone material including a mixture of siliglass and prosthetic deadener. For example, the soft cast silicone material may include a mixture ratio of 1 part siliglass to 6 parts prosthetic deadener.

In some embodiments, a cross-section through the aperture is substantially elliptical when viewed normal to the first surface or the second surface. The size of the aperture may decrease with increasing negative pressure. In some instances, the aperture is configured to close when the negative pressure applied across the simulated wound is greater than or equal to approximately 125 mm Hg.

In any of the above embodiments, the simulated tissue may further include a skin layer on the second surface of the body. In some instances, a thickness of the skin layer normal to the second surface may be less than a thickness of the body.

Another implementation of the present disclosure is a method of making a wound incision model. The method includes providing an outer frame defining an opening, providing an optically transparent panel, placing the panel into the opening in the outer frame, joining the panel to the outer frame along a perimeter of the panel, providing a simulated wound, placing the simulated wound into the panel, and pouring a body material onto the panel around the simulated wound to form a simulated tissue. The simulated wound includes at least two walls defining a perimeter of the aperture.

In some instances, the method includes applying a skin layer to an exposed surface of the simulated tissue.

In some embodiments, the method of providing the simulated wound further includes providing a central mold piece defining an aperture, providing an outer mold piece, applying a simulated wound material to one of the central mold piece and the outer mold piece, pressing the central mold piece against the outer mold piece, and separating the central mold piece from the outer mold piece. The simulated wound material may include a color pigment. In some instances, the method further includes joining the central mold piece to a scaffold configured to prevent movement of the central mold piece relative to the panel.

Another implementation of the present disclosure is a method of demonstrating an effectiveness of a negative pressure wound therapy (NPWT) dressing for use on an incisional wound. The method includes providing a wound incision model having a body disposed within an outer frame. The incision model includes a skin layer disposed upon a first side of the body and an aperture formed through the skin layer and the body. The method further includes applying the NPWT dressing to the skin layer over the aperture, applying a negative pressure to the NPWT dressing, and observing a deformation of the aperture from a second side of the body.

In some instances, the method includes measuring the deformation of the aperture. In some embodiments, the method includes removing the NPWT dressing from the skin layer and applying a new NPWT dressing to the skin layer.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a perspective view of a system for demonstrating wound closure effectiveness, according to an exemplary embodiment;

FIG. 2 is a perspective view of a wound incision model, according to an exemplary embodiment;

FIG. 3 is an exploded view of a wound incision model, according to an exemplary embodiment;

FIG. 4 is a front view of a wound incision model, according to an exemplary embodiment;

FIG. 5 is a side sectional view of a wound incision model, according to an exemplary embodiment;

FIG. 6 is a top sectional view of a wound incision model, according to an exemplary embodiment;

FIG. 7 is a perspective view of a cover of a wound incision model, according to an exemplary embodiment;

FIG. 8 is a perspective view of a base of a wound incision model, according to an exemplary embodiment;

FIG. 9 is a perspective view of a support piece of a wound incision model, according to an exemplary embodiment;

FIG. 10 is a front view of a wound incision model, according to another exemplary embodiment;

FIG. 11 is a block diagram of a method of demonstrating an effectiveness of a negative pressure wound therapy (NPWT) dressing for use on an incisional wound, according to an exemplary embodiment;

FIGS. 12-14 are images of a simulated wound in different states of closure, according to an exemplary embodiment;

FIG. 15 is a block diagram of a method of making a wound incision model, according to an exemplary embodiment;

FIG. 16 is a block diagram of a method of providing a simulated wound, according to an exemplary embodiment;

FIG. 17 is a perspective view of a scaffold used to facilitate manufacturing of a wound incision model, according to an exemplary embodiment.

### DETAILED DESCRIPTION

### Overview

Referring generally to the FIGURES, a wound incision model is provided. The wound incision model is used to demonstrate the proximal closure forces of dressings intended for use over closed incisional wounds. The model includes a simulated tissue disposed within an opening of an outer frame. The simulated tissue includes a simulated incisional wound extending through a body made from a cast silicone material. The cast silicone material is specifically formulated to have properties that are representative of human tissue in order to demonstrate the effects of applied pressures or forces across an incisional wound.

The model is configured to visually demonstrate the wound closure performance associated with different commercial negative pressure wound therapy (NPWT) systems and devices. A first side of the simulated tissue includes a skin layer to which a dressing of the NPWT device may be applied. The wound (e.g., dead space) may be viewed from an opposite side of the simulated tissue, through an optically transparent panel coupled to the body. According to an exemplary embodiment, the simulated incisional wound includes a color pigment, which allows the amount of wound closure to be observed and quantified during device operation. In this way, the closure performance provided by different devices may be directly compared. These and other features and advantages of the incision model are described in detail below.

### Incision Model Construction

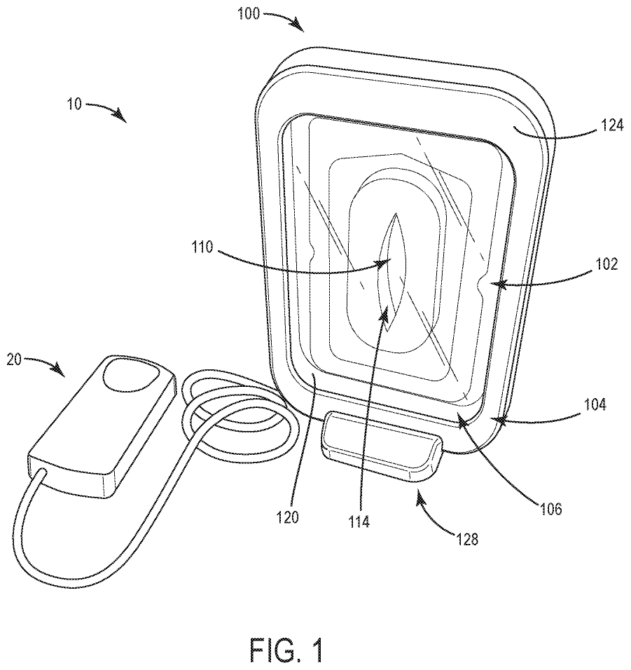

FIG. 1 provides a system 10 for demonstrating the incisional wound closure effectiveness of an NPWT device 20, according to an exemplary embodiment. The system 10 includes a wound incision model, shown as model 100. The model 100 is configured to provide a visual indication of an amount of wound closure caused by the NPWT device 20.

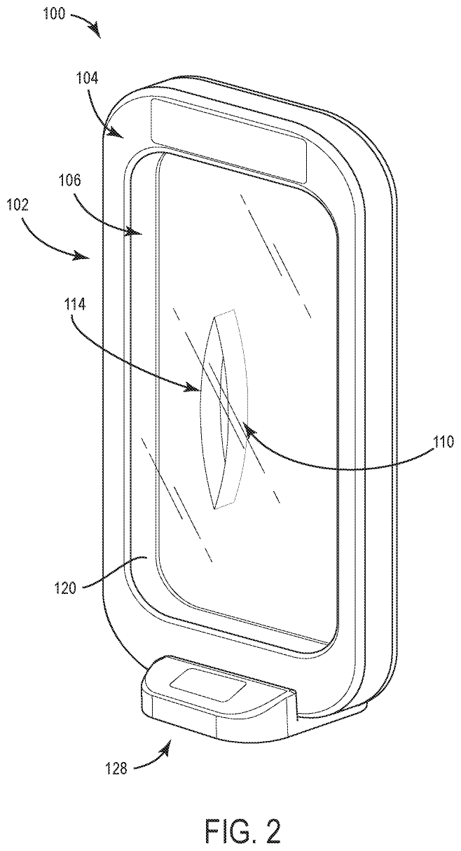

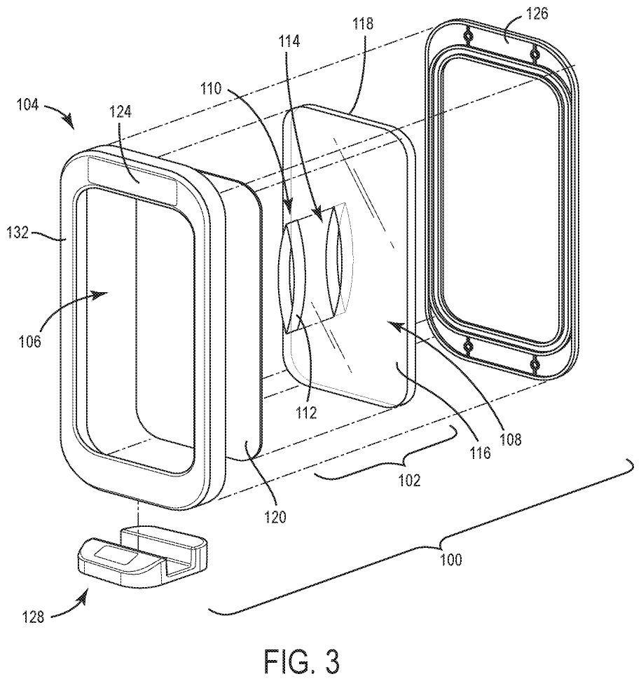

As shown in FIGS. 2-6, the model 100 includes a simulated tissue 102 surrounded circumferentially by an outer frame 104. In other words, the simulated tissue 102 is disposed within an opening 106 defined by the outer frame 104. As shown in FIG. 3, the simulated tissue 102 includes body 108 and a simulated wound, shown as wound 110. The wound 110 includes a plurality of walls 112 defining an aperture 114 extending through the body 108, from a first surface 116 of the body 108 to a second surface 118 of the body 108. As shown in FIGS. 2-3, the body 108 is optically transparent so that an observer may view the wound 110 from a variety of different angles. The walls 112 of the wound 110 include a coloring or a color pigment, which, advantageously, helps to distinguish the location of the wound 110 within the body 108. Moreover, the coloring also helps an observer identify when the wound 110 is fully closed.

According to an exemplary embodiment, the simulated tissue 102 (e.g., simulated wound 110) is configured to deform in response to a negative pressure applied across the simulated tissue 102. As shown in FIG. 3, the model 100 includes a panel 120 disposed on the first surface of the body 108. The panel 120 is coupled to the body 108 and seals against the body 108 to prevent air from entering the wound 110 through the first surface 116. As shown in FIGS. 2-3, the panel 120 is a generally optically transparent window through which an observer may view the deformation of the body 108 and the wound 110. The panel 120 is generally rectangular and substantially covers the first surface of the body 108.

Referring now to FIGS. 5-6, the simulated tissue 102 includes a skin layer 122 disposed on the second surface of the body 108. According to an exemplary embodiment, the skin layer 122 is configured to provide a more robust surface for repeated application and removal of medical dressings such as dressings for the NPWT device 20 of FIG. 1. The skin layer 122 is applied to the body 108 in an area that circumferentially surrounds the wound 110. According to an exemplary embodiment, the skin layer 122 completely covers the second surface 118. In other embodiments, the skin layer 122 only partially covers the second surface 118. For example, the skin layer 122 may extend from a perimeter of the wound 110 (e.g., proximate the walls 112) and cover an area of the second surface 118 that is slightly larger than a coverage area of the dressing for the NPWT device 20 (see also FIG. 1).

As shown in FIG. 3, the outer frame 104 is configured to support the simulated tissue 102 and to provide unimpeded visual access to the wound 110. The outer frame 104 includes a cover 124 and a base 126. The base 126 is coupled to the cover 124 proximate to an outer perimeter of the cover 124. The base 126 is detachably (e.g., removably) coupled to the cover 124, which, advantageously, allows a user to easily replace the simulated tissue 102 in the event it becomes damaged. The base 126 may be coupled to the cover 124 using a plurality of screws, clips, or another suitable mechanical fastener. In other embodiments, the base 126 may be welded or glued to the cover 124. As shown in FIG. 3, the outer frame 104 supports a layered stack of components including, from front to rear, the panel 120, the body 108, and the skin layer 122, respectively. Among other benefits, the outer frame 104 conceals the cast edges of the simulated tissue 102 in order to improve the aesthetic of the model 100.

As shown in FIG. 3, the panel 120 is “sandwiched” or otherwise disposed between the cover 124 and the simulated tissue 102 (e.g., the body 108). The body 108 of the simulated tissue 102 is cast directly onto the panel 120 in order to ensure an air-tight seal between the body 108 and the panel 120. The simulated tissue 102 is “sandwiched” or otherwise disposed between the panel 120 and the base 126. As shown in FIGS. 5-6, the skin layer 122 of the simulated tissue 102 is “sandwiched” or otherwise disposed between the body 108 the base 126 along a perimeter of the skin layer 122. In other embodiments, the body 108 engages directly with the base 126 along a perimeter of the body 108.

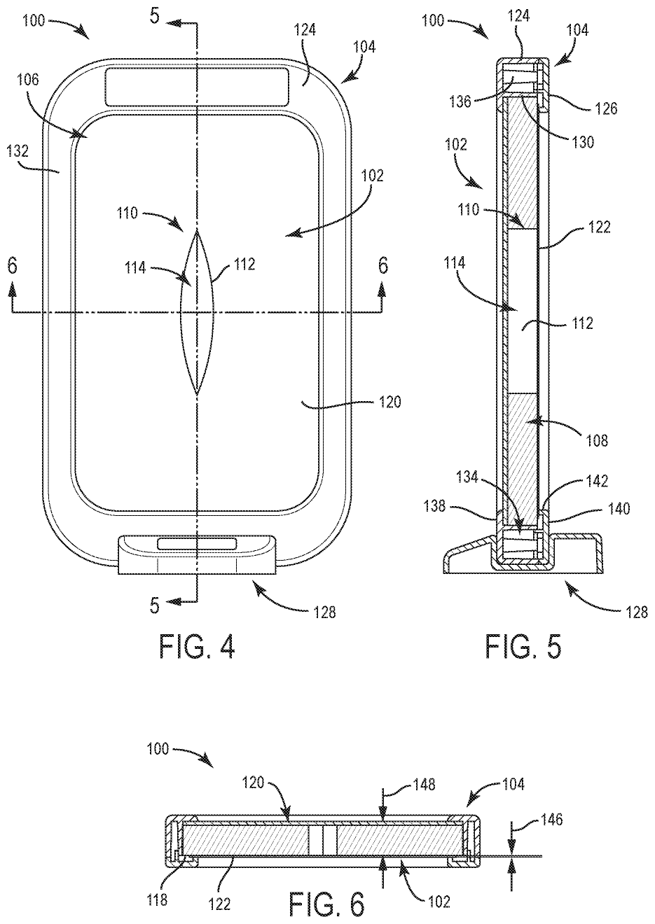

According to an exemplary embodiment, the model 100 includes a support piece 128 configured to stabilize the model 100 upon a mounting surface (e.g., a horizontal surface, etc.) and orient the model 100 relative to the mounting surface. As shown in FIGS. 4-5, the support piece 128 supports the model 100 in a substantially perpendicular orientation relative to the mounting surface (e.g., substantially vertically relative to a horizontal mounting surface). As shown in FIG. 4, the support piece 128 is detachably coupled to the outer frame 104. According to an exemplary embodiment, the support piece 128 is pressed on to the outer frame 104 and is secured in position relative to the outer frame 104 via a friction fit. In some embodiments, the support piece 128 is screwed or otherwise fastened to the outer frame 104. In other embodiments, the support piece 128 is permanently affixed to the outer frame 104 via welding, gluing, or another suitable bonding operation.

As shown in FIG. 1, a dressing of the NPWT device 20 is placed across the skin layer 122 and completely covers the wound 110. The dressing is sealably engaged with the skin layer 122 so that a negative pressure may be applied across the simulated wound 110. The simulated wound 110 is configured to deform in response to the negative pressure applied by the NPWT device 20. According to an exemplary embodiment, the size of the aperture 114 decreases with increasing negative pressure. An observer may visually inspect the deformation of the simulated wound 110 through the panel 120 while the NPWT device 20 is operational.

### Outer Frame

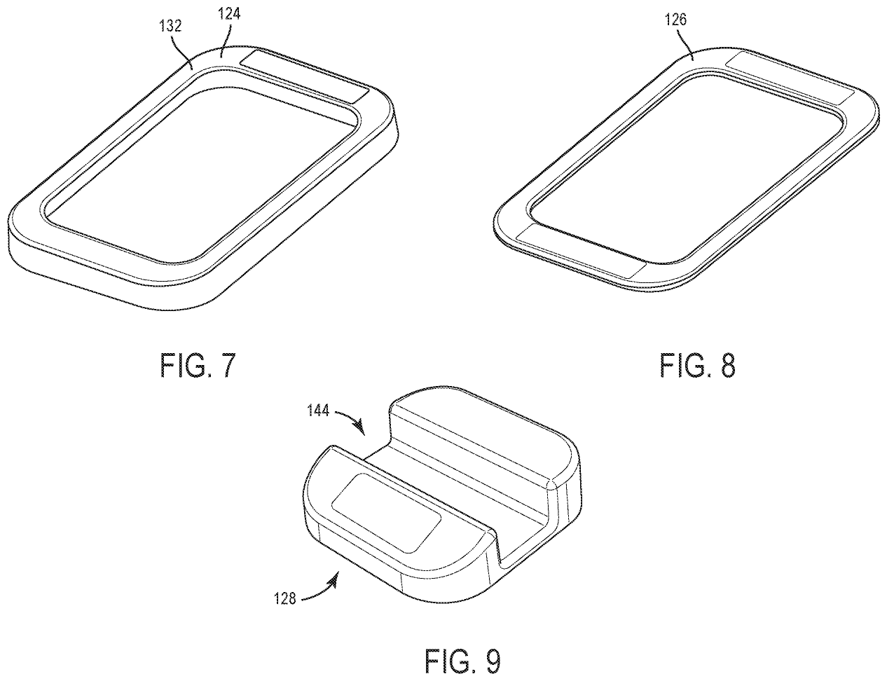

FIGS. 4-9 provide various views of an outer frame 104 of the wound incision model 100, according to an exemplary embodiment. The outer frame 104 defines an opening 106 configured to receive the simulated tissue 102 therein. The opening 106 is generally rectangular. In other embodiments, a size and/or shape of the opening 106 may be different. For example, the opening 106 may be circular, an oval shape, or another suitable shape. As shown in FIGS. 4-6, the outer frame 104 is a three-part assembly including a cover 124, a base 126, and a support piece 128. In alternative embodiments, the outer frame 104 may include additional, fewer, and/or different components. As shown in FIGS. 5-6, the cover 124 includes two protrusions 130 extending outwardly from a forward wall 132 of the cover 124 in substantially perpendicular orientation relative to a forward wall 132. Together, the protrusions 130 at least partially define a generally “U” shaped channel 134. The channel 134 extends circumferentially between an inner and outer perimeter of the cover 124. The cover 124 additionally includes a plurality of internally threaded posts 136 disposed centrally within the channel 134. As shown in FIGS. 4 and 6, the posts 136 are alignable with holes in the base 126 such that a fastener can be received therein to couple the cover 124 to the base 126. According to an exemplary embodiment, the protrusions 130 and posts 136 are integrally formed with the cover 124 as a single unitary structure. In alternative embodiments, the posts 136 may be replaced or combined with clips or another suitable fastener.

As shown in FIGS. 5-6, the base 126 engages with an outer edge of the protrusions 130 at the top of the channel 134, blocking off the channel and thereby forming an enclosed volume. Both the cover 124 (e.g., the forward wall 132) and the base 126 include ledges, shown as forward ledge 138 and rear ledge 140, respectively, extending substantially inwardly, away from an inner protrusion 130 and toward the opening 106. As shown in FIGS. 5-6, the forward ledge 138 is configured to engage with the panel 120. The rear ledge 140 is configured to engage with the simulated tissue 102 (e.g., the skin layer 122 or the body 108). According to an exemplary embodiment, each of the ledges 138, 140 include a lip 142 (e.g., hook, etc.) extending along an inner perimeter of the ledges 138, 140. Among other benefits, the lips 142 help maintain frictional engagement between the outer frame 104 and the panel 120 (or simulated tissue 102) in order to prevent the panel 120 and/or the simulated tissue 102 from separating from the outer frame 104. Additionally, the lip 142 prevents overflow of any adhesive product that may be used to further secure the panel 120 and/or simulated tissue 102 in position with respect to the outer frame 104.

According to an exemplary embodiment, the outer frame 104 includes a support piece 128 configured to support the model 100 upon a mounting surface and orient the support piece 128 relative to the mounting surface. The mounting surface may be a table top surface such as a display table or another suitable horizontal surface. As shown in FIGS. 4-5, the support piece 128 is configured to position the model 100 in substantially perpendicular orientation relative to the mounting surface (e.g., substantially vertically relative to a horizontal surface). The support piece 128 is detachably (e.g., removably) coupled to the cover 124 and the base 126 via a friction fit. FIG. 9 shows the support piece 128 separated from the cover 124 and the base 126. As shown, the support piece 128 includes a recessed area 144 defining a generally “U” shaped channel configured to receive the cover 124 and the base 126 therein. In other embodiments, the support piece 128 may be screwed, bolted, or otherwise fastened to the cover 124 and the base 126.

According to an exemplary embodiment, the outer frame 104 (e.g., the cover 124, the base 126, and the support piece 128) is made from a plastic material such as injection molded acrylonitrile butadiene styrene (ABS). In another embodiment, the outer frame 104 is made from laser cut cast acrylic or another suitable plastic.

### Panel

Referring now to FIGS. 4-6, the panel 120 is configured to support the simulated tissue 102 against the cover 124 of the outer frame 104. The panel 120 is sealably engaged with the body 108 along the first surface 116 of the body 108. According to an exemplary embodiment, the panel 120 is generally the same shape as the body 108 (e.g., rectangular as shown in FIGS. 4-6). The panel 120 is optically transparent in order to provide an observer with unimpeded visual access to the wound 110. The panel 120 may be made from a variety of different materials. According to an exemplary embodiment, the panel 120 includes a clear acrylic panel or another transparent plastic. In yet other embodiments, the panel 120 may include glass.

### Simulated Tissue

As shown in FIG. 3, the simulated tissue 102 includes a body 108 and a simulated wound 110. The body 108 includes a generally rectangular slab or block of material. According to an exemplary embodiment, the body 108 includes a soft cast silicone material. Among other benefits, the soft cast silicone material provides similar properties (e.g., elasticity, etc.) to human tissue, resulting in a more life-like model from which the performance of different NPWT devices/dressings can be more easily quantified Similar to the panel 120, the soft cast silicone material is optically transparent in order to provide unimpeded visual access to the wound 110. The silicone material may be cast or otherwise formed using a mixture of cured silicone and prosthetic deadener. The cured silicone may be, for example, Mouldlife Siliglass or another commercially available Siliglass product. The deadener may be, for example, Mouldlife Smiths Prosthetic Deadener or another commercially available silicone deadener product. Among other benefits, the silicone deadener reduces the synthetic feel of the silicone in order to better simulate the properties of human tissue. The mixture ratio of the cured silicone and prosthetic deadener may vary depending on the desired material properties. According to an exemplary embodiment, a mixture ratio of siliglass to prosthetic deadener is approximately 1 to 6 (e.g., 1 part siliglass to 6 parts prosthetic deadener, 600% prosthetic deadener, etc.).

As shown in FIGS. 4-6, the wound 110 is disposed at least partially within the body 108. For example, the wound 110 may be disposed centrally within the body 108. The wound 110 includes a plurality of walls 112 defining a perimeter of an aperture 114 through the body 108, from the first surface 116 of the body 108 to the second surface 118 of the body 108. As shown in FIG. 4, the walls 112 are oriented in a substantially perpendicular orientation relative to both the first surface 116 and the second surface 118. The walls 112 may be made from the same or a different material than the body 108. According to an exemplary embodiment, the walls 112 are made from a 20 Shore A or 30 Shore A addition cured silicone such as FS-T20. The walls 112 may include a coloration or a color pigment so that the wound 110 may be more easily identified and observed. The coloration may help an observer to identify closure events where the walls 112 are brought into contact with one another. A thickness of the walls may be 0.5 mm or another suitable thickness depending on the manufacturing process and the desired material properties of the wound 110.

According to an exemplary embodiment, the simulated wound 110 is configured to deform in response to a negative pressure applied across the simulated wound 110. The negative pressure results in a lateral appositional force that pulls the walls 112 inward (e.g., toward one another, left-to-right as shown in FIG. 4). The walls 112 are configured to bend, bow, or otherwise deform in response to the negative pressure in order to simulate at least partial wound closure in human tissue. The walls 112 are configured to deform such that the size (e.g., cross-sectional area) of the aperture 114 decreases with increasing negative pressure.

The aperture 114 may be a variety of different shapes. According to an exemplary embodiment, the wound 110 simulates an incisional wound. In other words, the aperture 114 is generally elliptical (e.g., a cross-section through the aperture 114 is substantially elliptical when viewed normal to the first surface 116 or the second surface 118). A maximum width of the wound 110 in a lateral direction (e.g., left-to-right as shown in FIG. 4) may be 16 mm, 20 mm, or another suitable width. According to an exemplary embodiment, the maximum width of the wound 110 is selected to demonstrate complete closure of the wound 110 under a given negative pressure. For example, the maximum width of the aperture 114 may be sized such that the aperture 114 is configured to close when the negative pressure applied across the simulated wound 110 is greater than or equal to approximately 125 mm Hg.

As shown in FIGS. 5-6, the simulated tissue 102 includes a skin layer 122 disposed on the second surface 118 of the body 108. The skin layer 122 includes a thin layer of silicone that substantially covers the second surface 118. As shown in FIG. 6, a thickness 146 of the skin layer 122 in a direction normal to the second surface 118 (e.g., vertically up and down as shown in FIG. 6) is substantially less than a thickness 148 of the body 108. According to an exemplary embodiment, the skin layer 122 includes a room-temperature-vulcanizing (RTV) silicone such as Europol RTV 340 or another firm rubber casting product. Among other benefits, the skin layer 122 provides a durable surface to which the NPWT dressing 20 (see also FIG. 1) may be applied. According to an exemplary embodiment, the skin layer 122 is strong enough to withstand repeated redressing of the simulated wound 110.

### Additional Layers and Configurations

The combination of features shown in the exemplary embodiments of FIGS. 1-6 should not be considered limiting. Many alternative implementations are possible without departing from the inventive concepts disclosed herein. For example, in some embodiments, the shape of the model 100 may be different (e.g., circular, etc.). The materials used in each layer may also vary in order to better demonstrate the difference in performance between different NPWT devices/dressings. In some embodiments, the model 100 may further include lights, sensors, and/or other components to improve visibility of wound deformation and to more accurately quantify an amount of deformation of the wound 110 in response to an applied negative pressure.

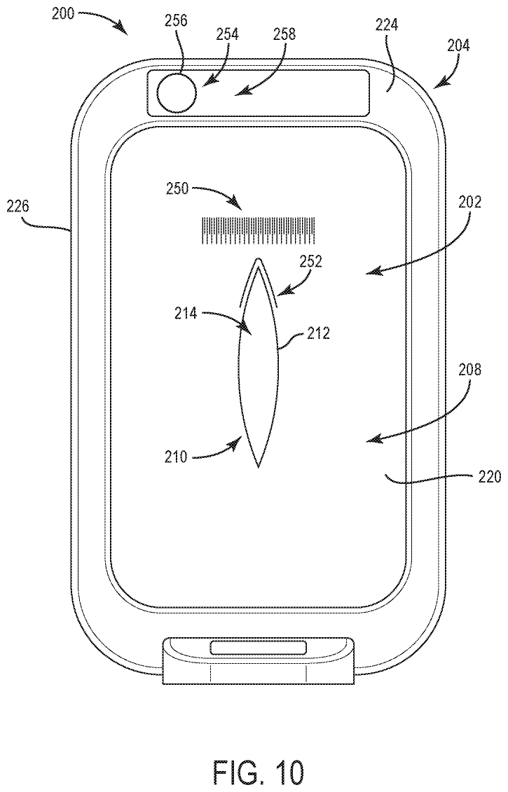

For example, FIG. 10 provides a wound incision model, shown as model 200 that includes a variety of components configured quantify the performance of different NPWT devices/dressings 20 (see also FIG. 1). As shown in FIG. 10, the model 200 includes a simulated tissue 202 and an outer frame 204. The simulated tissue 202 and the outer frame 204 may be the same as or similar to the simulated tissue 102 and outer frame 104 described with reference to the model 100 of FIGS. 1-9. For convenience, like numerals will be used to denote like components. As shown in FIG. 10, the model 200 includes rule gradations 250 disposed on a forward surface of the panel 220. The rule gradations 250 are configured to measure a deformation of the aperture 214 in response to an applied negative pressure. According to an exemplary embodiment, the rule gradations 250 are disposed proximate an upper edge of the aperture 214 or near another edge of the aperture 214 in order to provide an observer with a reference from which the extent of lateral deformation may be quantified. The rule gradations 250 may show a spacing of 1 mm or another suitable dimension depending on the size of the aperture 214 and/or the performance of the NPWT device.

As shown in FIG. 10, the model 200 additionally includes a plurality of sensors. Each one of the sensors is configured to measure at least one of a deformation of the simulated wound 210 or the negative pressure applied across the simulated wound 210. As shown in FIG. 10, the model 100 includes an electro-active polymer (EAP) sensor 252 disposed along and offset from an upper edge of the simulated wound 210. The EAP sensor 252 is configured to measure a deformation of the wound 210 (e.g., an amount of closure between the walls 212 of the aperture 214, a reduction in aperture 214 size, etc.). As shown in FIG. 10, the EAP sensor 252 is disposed substantially within the body 208. According to an exemplary embodiment, the EAP sensor 252 is integrally molded with the body 208 on either side of a central reference line through the wound 210. The EAP sensor 252 is configured to extend and deform with the body 208 in response to the negative pressure applied across the simulated wound 210. In some embodiments, the EAP sensor 252 may also be anchored or otherwise coupled to the outer frame 204 to provide a fixed reference point from which the EAP sensor 252 may extend.

As shown in FIG. 10, the model 200 additionally includes a pressure sensor 254 (e.g., a pneumatic pressure sensor, etc.) including a dial pressure gage 256. According to an exemplary embodiment, the pressure sensor 254 is fluidly coupled to the wound 210 (e.g., the aperture 214) via a conduit extending at least partially through the body 208, or between the body 208 and the panel 220. The negative pressure may be interpreted and displayed by the dial pressure gage 256. As shown in FIG. 10, the dial pressure gage 256 is disposed in the outer frame 204 within the cover 224. According to an exemplary embodiment, the pressure sensor 254 forms part of an electronics module 258 disposed at least partially within the outer frame 204. For example, the electronics module 258 may be at least partially disposed within the enclosed volume formed between the cover 224 and the base 226. Among other benefits, positioning the electronics module 258 within the outer frame 204 conceals the electronics module 258 and improves the overall aesthetic of the model 200. The sensors may be electrically coupled to the electronics module 258 via bonding wires disposed within the body 208 and/or the outer frame 204.

According to an exemplary embodiment, the electronics module 258 includes a network communications interface configured to wirelessly transmit sensor data from the plurality of sensors over a network. The network may include a long or short-range communications network such as a Bluetooth network, a Zigbee network, etc. The network may also include a local area network (LAN), a wide area network (WAN), a telecommunications network, the Internet, a public switched telephone network (PSTN), and/or any other type of communication network known to those of skill in the art. The network communications interface may be configured to transmit sensor data to a mobile phone, a smart phone, a laptop computer, or another network connected device. The device may include an application configured to graphically display sensor data (e.g., in real-time). For example, the application may be configured to display closure force and/or deformation measured by the EAP sensor 252, the negative pressure measured by the pressure sensor 254, or other calculated or derived metrics. In other embodiments, the pressure sensor 254 may be a standalone sensor configured to output negative pressure measurements to the dial pressure gage 256 for in-situ observation during a performance test.

### Method of Demonstrating an Effectiveness of a NPWT Dressing

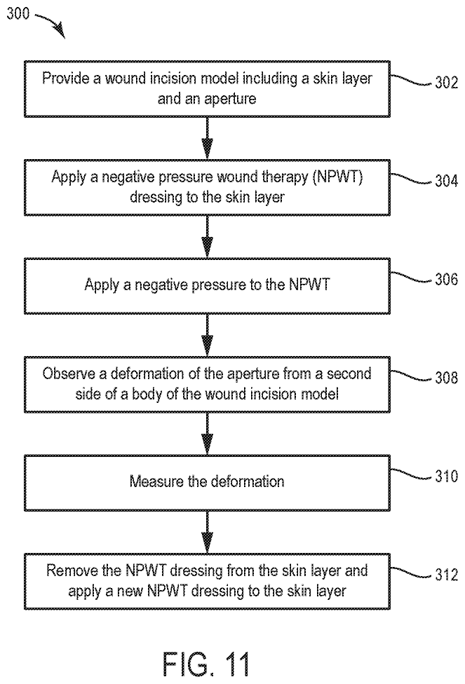

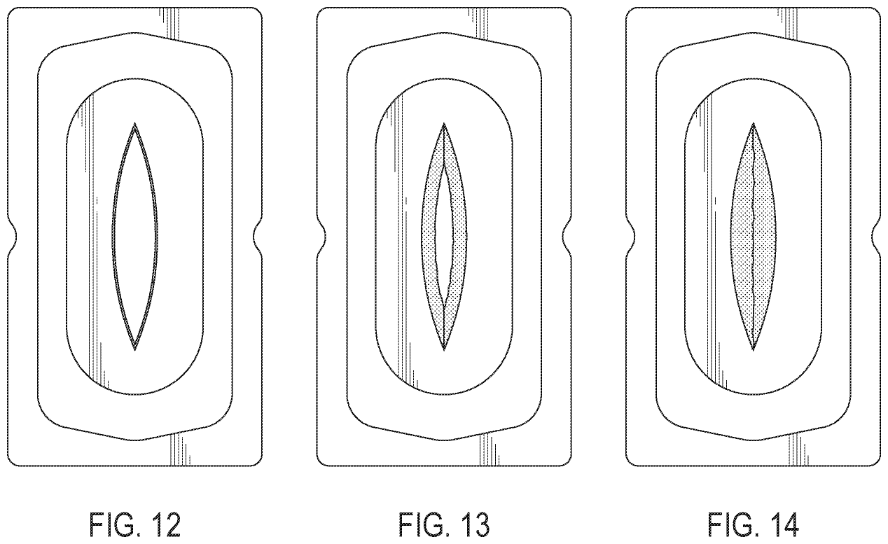

Referring now to FIG. 11, a method 300 of demonstrating an effectiveness of an NPWT dressing for use on an incisional wound is shown, according to an exemplary embodiment. In other embodiments, the method 300 may include additional, fewer, and/or different operations. In operation 302, a wound incision model including a skin layer and an aperture is provided. The wound incision model may be the same or similar to the wound incision models 100, 200 of FIGS. 1-9 and FIG. 10, respectively. The wound incision model may be positioned on a mounting surface such as a display table. In operation 304, an NPWT dressing/device is applied to the skin layer of the model. According to an exemplary embodiment, the NPWT device is a dressing of an incision management system such as the PREVENA™ Incision Management System by KCI. Operation 304 may additionally include preparing a patient interface layer of the NPWT dressing 20 (see also FIG. 1) and aligning the dressing with the simulated wound. Operation 304 may also include pressing the patient interface layer against the skin layer of the model in order to provide an air-tight seal between the patient interface layer and the skin layer.

In operation 306, a negative pressure is applied across the wound by the NPWT device 20. This may include activating a pump within the device to remove air from the dressing (e.g., the aperture in the simulated tissue). In operation 308, an observer may visually inspect the deformation of the aperture. The observer may view the wound from the second side of the body of the model, through the transparent panel. FIGS. 12-14 show images of the simulated wound taken through the panel during a NPWT device demonstration. As shown in FIG. 12, in the absence of an applied negative pressure, the walls of the wound are in substantially perpendicular orientation relative to the panel (e.g., the first surface of the body). As shown in FIGS. 13-14, the size of the aperture decreases with increasing negative pressure. FIG. 14 shows a closure event, where the negative pressure applied across the wound results in complete closure of the aperture.

In operation 310, the deformation of the wound (e.g., the reduction in size of the aperture) is measured. The measurement may be performed by referencing a rule gradation on the panel, via an EAP sensor, or via another relative position sensor coupled to the wound. In operation 312, the NPWT dressing is removed from the skin layer and the wound is redressed with a new NPWT dressing. Operation 312 may include removing the patient interface layer of the original NPWT dressing by peeling the layer off from the skin layer.

### Method of Making a Wound Incision Model

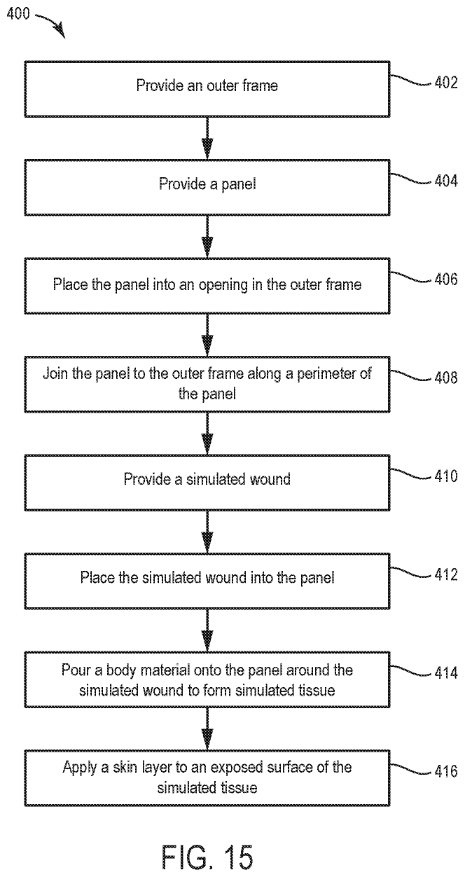

Referring now to FIG. 15, a method 400 of making a wound incision model is shown, according to an exemplary embodiment. In other embodiments, the method 400 may include additional, fewer, and or different operations. As shown in FIG. 15, the method 400 includes providing an outer frame (operation 402) and providing a panel (operation 404). In operation 406, the panel is placed within the outer frame. Operation 406 may additionally include aligning the panel with the opening in the cover. In operation 408, the panel is joined to the outer frame (e.g., cover) along a perimeter of the panel. Operation 408 may further include applying a clear silicone adhesive or another suitable adhesive around a perimeter of the panel, between the panel and the cover, in order to seal the panel to the cover.

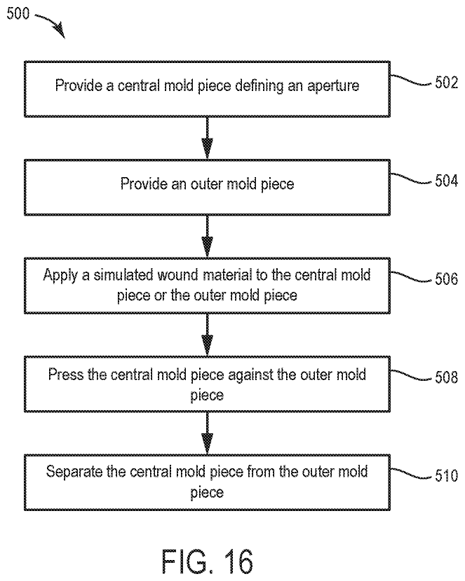

In operation 410, a simulated wound is provided. FIG. 16 shows a method 500 of making a simulated wound for a wound incision model, according to an exemplary embodiment. The method 500 includes providing a central mold piece defining an aperture (operation 502) and an outer mold piece (operation 504). The central (e.g., male) mold piece may be generally elliptical. The female mold piece may be configured to substantially surround and press against the outer surfaces of the central mold piece. The female mold piece may include multiple separate pieces that fit together around the central mold piece. In operation 506, a simulated wound material is applied to one of the central mold piece and the outer mold piece. Operation 506 may additionally include applying a simulated wound material to the outside faces of the central mold piece and/or the interior faces of the outer mold piece. The material may be painted or otherwise deposited onto the mold pieces.

In operation 508, the central mold piece is pressed against the outer mold piece. The outer mold piece is positioned in contact with the central mold piece. Clamps may be applied to the outer mold piece to increase the contact pressure between the central mold piece and the outer mold piece. In operation 510, the outer mold piece is removed and separated from the central mold piece. Operation 510 may additionally include trimming the wound material to remove unwanted edges and to clean up any remaining flash from the molding process.

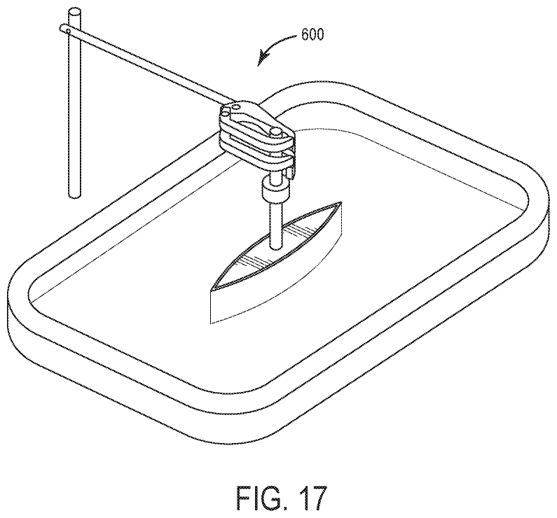

Returning now to FIG. 15, the method 400 of making the wound incision model further includes placing the simulated wound into the panel, shown as operation 412. Operation 412 may additionally include positioning the central mold piece toward the middle of the panel and joining the central mold piece to a scaffold. The scaffold may be configured to prevent movement of the central mold piece relative to the panel. FIG. 17 provides a scaffold 600 that may be used to help secure the central mold piece in position upon the panel, according to an exemplary embodiment. The scaffold 600 includes a support pole and a burette clamp. In other embodiments, the components used to support the central mold piece may be different.

In operation 414 (see FIG. 15), a body material is poured onto the panel around the simulated wound to form simulated tissue. The body material may substantially fill the cover of the outer frame. Operation 414 may additionally include mixing a cast silicone material with a synthetic deadener. Operation 414 may further include preparing a mixture of cast silicone and deadener in a mixture ratio of approximately 1 to 6, respectively, or as needed in order to obtain properties similar to human tissue. In operation 416, a thin skin layer of silicone RTV is applied to an exposed surface (e.g., a second surface) of the simulated tissue (e.g., the body). Operation 416 may include painting the skin layer onto the simulated tissue.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

1. A wound incision model, comprising:
an outer frame defining an opening; and
a simulated tissue disposed at least partially within the opening, wherein the simulated tissue comprises:
a body; and
a simulated wound disposed at least partially within the body, wherein the simulated wound comprises an aperture extending through the body from a first surface of the body to a second surface of the body, and wherein the simulated wound is configured to deform in response to a negative pressure applied across the simulated wound.

2. The wound incision model of claim 1, wherein the simulated wound further comprises at least two walls defining a perimeter of the aperture, wherein the walls are oriented substantially normal to the first surface or the second surface, and wherein the walls are configured to deform in response to the negative pressure applied across the simulated wound.

3. The wound incision model of claim 2, wherein the walls comprise a different material than the body, and wherein the walls include a color pigment.

4. The wound incision model of claim 1, wherein the body is substantially transparent.

5. (canceled)

6. The wound incision model of claim 1, wherein a size of the aperture decreases with increasing negative pressure, and wherein the aperture is configured to close when the negative pressure applied across the simulated wound is greater than or equal to approximately 125 mm Hg.

7. The wound incision model of claim 1, wherein the body comprises a soft cast silicone material.

8. The wound incision model of claim 7, wherein the soft cast silicone material comprises a mixture of siliglass and prosthetic deadener.

9. The wound incision model of claim 8, wherein a mixture ratio of siliglass to prosthetic deadener is approximately 1 to 6.

10. The wound incision model of claim 1, further comprising a panel disposed on the first surface of the body, wherein the panel is optically transparent.

11. The wound incision model of claim 10, wherein the panel comprises rule gradations configured to measure deformation of the aperture.

12. The wound incision model of claim 1, wherein the simulated tissue further comprises a skin layer on the second surface of the body, wherein a thickness of the skin layer normal to the second surface is less than a thickness of the body normal to the second surface.

13. The wound incision model of claim 1, further comprising a sensor configured to measure at least one of a deformation of the simulated wound or the negative pressure applied across the simulated wound.

14. The wound incision model of claim 13, wherein the sensor comprises an electro-active polymer (EAP) sensor molded into the body, wherein the EAP sensor is configured to extend and deform with the body in response to the negative pressure applied across the simulated wound.

15. The wound incision model of claim 13, further comprising an electronics module disposed at least partially within the outer frame, wherein the sensor is electrically coupled to the electronics module, and wherein the electronics module includes a network communications interface configured to wirelessly transmit sensor data from the sensor.

16. The wound incision model of claim 13, wherein the sensor comprises a pneumatic pressure sensor comprising a dial pressure gage, and wherein the dial pressure gage is at least partially disposed within the outer frame.

17. A simulated tissue, comprising:
a body; and
a simulated wound disposed at least partially within the body, wherein the simulated wound comprises an aperture extending through the body from a first surface of the body to a second surface of the body, and wherein the simulated wound is configured to deform in response to a negative pressure applied across the simulated wound.

18. (canceled)

19. (canceled)

20. (canceled)

21. The simulated tissue of claim 17, wherein a size of the aperture decreases with increasing negative pressure, and wherein the aperture is configured to close when the negative pressure applied across the simulated wound is greater than or equal to approximately 125 mm Hg.

22. The simulated tissue of claim 17, wherein the body comprises a soft cast silicone material.

23. The simulated tissue of claim 22, wherein the soft cast silicone material comprises a mixture of siliglass and prosthetic deadener.

24. The simulated tissue of claim 23, wherein a mixture ratio of siliglass to prosthetic deadener is approximately 1 to 6.

25. The simulated tissue of claim 17, further comprising a skin layer on the second surface of the body, wherein a thickness of the skin layer normal to the second surface is less than a thickness of the body normal to the second surface.

26. (canceled)

27. (canceled)

28. (canceled)

29. (canceled)

30. A method of demonstrating an effectiveness of a negative pressure wound therapy (NPWT) dressing for use on an incisional wound, the method comprising:
providing a wound incision model having a body disposed within an outer frame, the incision model comprising:
a skin layer disposed upon a first side of the body, and
an aperture formed through the skin layer and the body;
applying the NPWT dressing to the skin layer over the aperture;
applying a negative pressure to the NPWT dressing;
observing a deformation of the aperture from a second side of the body.

31. The method of claim 30, further comprising measuring the deformation.

32. The method of claim 30, further comprising removing the NPWT dressing from the skin layer and applying a new NPWT dressing to the skin layer.
